(19) United States
(12) Patent Application Publication
(10) Pub. No.: US 2023/0075708 A1
(43) Pub. Date: Mar. 9, 2023

(54) SMART PARTS BIN APPARATUS AND SYSTEM

(71) Applicant: Robert Carryl, Jacksonville, FL (US)

(72) Inventor: Robert Carryl, Jacksonville, FL (US)

(21) Appl. No.: 17/899,794

(22) Filed: Aug. 31, 2022

Related U.S. Application Data
(60) Provisional application No. 63/240,830, filed on Sep. 3, 2021.

(51) Int. Cl. G06Q 10/08; G01F 23/292

(52) U.S. Cl. CPC G06Q 10/0875; G01F 23/2921

(57) ABSTRACT

A smart parts bin apparatus including a light source configured to emit a light signal, a detector configured to detect the light signal emitted by the light source, an inner surface defining a volume configured to retain one or more parts, wherein the light source and the detector are each affixed to the inner surface and arranged on opposing sides of the inner surface within the volume, and a signal source configured to provide an inventory status signal, including a first type of signal when the light signal emitted by the light source is not detected by the detector indicating that a level of parts in the smart parts bin apparatus is above a threshold inventory level, and a second type of signal when the light signal is detected by the detector indicating that the level of parts in the smart parts bin apparatus is below the threshold inventory level.

### RELATED APPLICATION

This application claims priority to U.S. Provisional Application Ser. No. 63/240,830, filed on Sep. 3, 2021, the entire contents of which are hereby incorporated by reference.

### TECHNICAL FIELD

This specification relates to parts bins.

### BACKGROUND

Parts bins are used by manufacturers to store parts (or other items) so that the parts are available when needed, for example, during manufacturing operations.

### SUMMARY

This specification describes technologies for a smart parts bin apparatus. More generally, a smart parts bin apparatus includes a light source (e.g., light emitting device (LED)) and a sensor that can be utilized to detect items within a parts bin. The light source and sensor can be arranged with respect to each other such that a light signal from the light source is detected by the sensor when contents of the parts bin is below a threshold occupancy (e.g., when the parts level falls below a certain level within the parts bin).

The smart parts bin can further include an inventory status device (e.g., one or more LEDs) which can be selectively turned on/off (or have its color changed) to provide a visual alert in response to a detection state of the sensor to the light signal of the light source. The inventory status device can be positioned such that a visual signal from the inventory status device is visible on a front panel of the smart inventory bin.

The smart parts bin can further provide an inventory status signal to a smart inventory system via a network, which can be utilized by the smart inventory system to perform inventory control. In other words, the smart parts bin can generate a trigger signal that either (i) triggers another device to generate digital data that is transmitted to the smart inventory system (e.g., over a network), or (ii) includes the digital data that is transmitted to the smart inventory system.

In general, one innovative aspect of the subject matter described in this specification can be embodied in an apparatus including a light source configured to emit a light signal, a detector configured to detect the light signal emitted by the light source, an inner surface defining a volume configured to retain one or more parts, wherein the light source and the detector are each affixed to the inner surface and arranged on opposing sides of the inner surface within the volume, and a signal source configured to provide an inventory status signal. The signal source outputs a first type of signal when the light signal emitted by the light source is not detected by the detector indicating that a level of parts in the smart parts bin apparatus is above a threshold inventory level, and the signal source outputs a second type of signal when the light signal emitted by the light source is detected by the detector indicating that the level of parts in the smart parts bin apparatus is below the threshold inventory level.

The foregoing and other embodiments can each optionally include one or more of the following features, alone or in combination. In particular, one embodiment includes all the following features in combination. In some implementations, the apparatus further includes a control unit in data communication with the light source, detector, and signal source, and is configured to perform operations including receiving, by the control unit, a detection signal from the detector for the light signal emitted by the light source, and determining, by the control unit, a detection signal of a plurality of detection signals from the detector, where the detection signal reflects a number of the one or more parts retained within the volume. In response to the determination that the detection signal from the detector is a first detection signal, the control unit is configured to provide a first control signal to the signal source to generate a first inventory status signal, and in response to the determination that the detection signal from the detector is a second detection signal, the control unit is configured to provide a second control signal to the signal source to generate a second inventory status signal.

In some implementations, the first detection signal includes no detection of the light signal emitted by the light source, and the second detection signal includes detection of the light signal emitted by the light source.

In some implementations, the signal source is a light emitting diode (LED). The first inventory status signal can include setting the LED to emit a first light signal, and wherein the second inventory status signal comprises setting the LED to emit a second light signal.

In some implementations, the light source is an LED and the detector is one of a photodiode, CCD, CMOS camera, phototransistor, or photoresistor.

In some implementations, the operations further include providing, to an smart inventory system, an alert comprising information regarding the detection signal.

The subject matter described in this specification can be implemented in particular embodiments so as to realize one or more of the following advantages. The smart parts bin includes a front-facing visual indicator (e.g., a green/red LED light) that can be utilized by a user to quickly and efficiently determine whether a parts bin includes a sufficient level of parts (or other items) without having to remove the parts bin from a rack. By visually conveying whether a parts bin includes a sufficient level of parts, a manufacturer (or other user) can avoid costly-downtime that can result from lack of critical parts used the maintain support systems of fabrication/manufacturing systems. Providing a visual indicator of inventory status of multiple bins that can be assessed by a user from a distance and without requiring the user to open and/or visually inspect the contents of each parts bin individually can improve the efficiency and time-management of performing inventory control. Utilizing a light source/sensor apparatus to monitor a threshold contents of each of multiple smart parts bins can be a low-cost, effective solution. An insert including the light source, sensor, and inventory status device can be provided as an adaptive kit to retrofit existing parts bins without requiring upgrading an existing parts bin storage system. For example, clips (or adhesive) can be used to secure the light source, sensor, and inventory status device to an existing parts bin, thereby converting it into a smart parts bin.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1B are block diagrams depicting an example operating environment of the smart parts bin.

FIGS. 2A-2B are examples of smart parts bins systems.

FIG. 3 is a flow diagram of an example process of the smart parts bin.

FIG. 4 is a block diagram of an example computer system.

Like reference numbers and designations in the various drawings indicate like elements.

### DETAILED DESCRIPTION

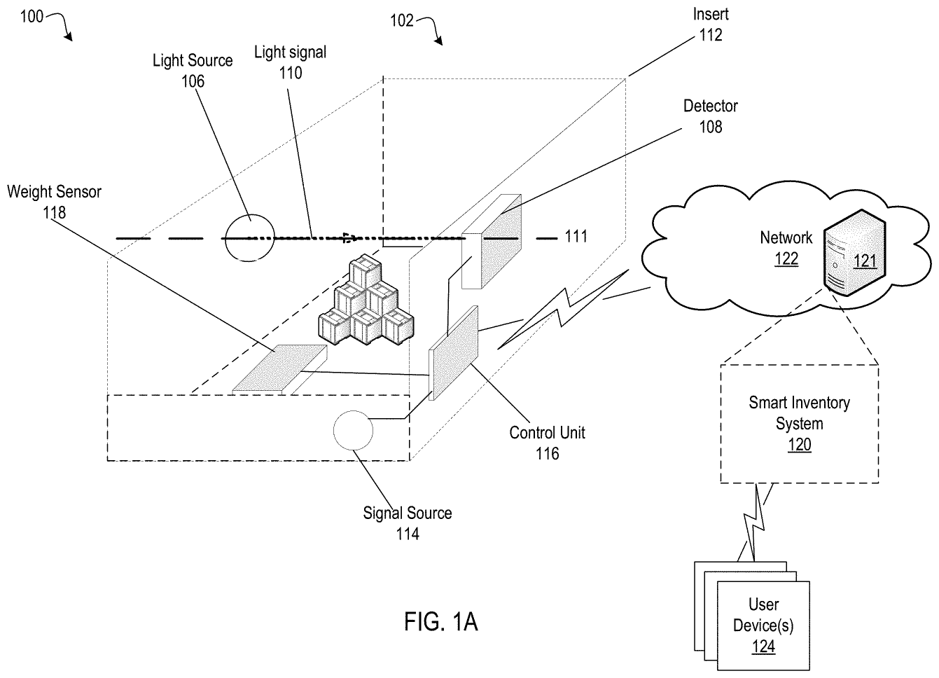

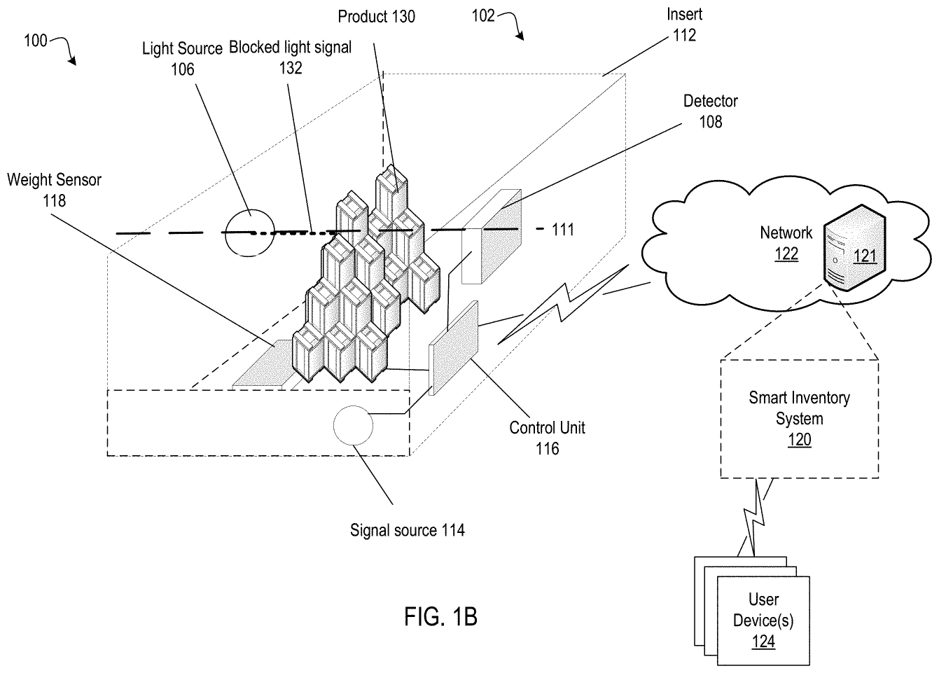

FIGS. 1A-1B are block diagrams depicting an example operating environment 100 of the smart parts bin 102. As depicted in FIG. 1A, smart parts bin 104 includes a light source 106, e.g., a light emitting diode (LED), laser (e.g., an infrared or visible light laser), or another source of light signal, and a detector 108, e.g., a charge-coupled device (CCD), complimentary metal-oxide-semiconductor (CMOS) sensor, photodiodes, photoresistors, phototransistors, or other form of photodetector. Detector 108 is configured to detect a light signal emitted by the light source 106, e.g., if light source 106 is an LED emitting a visible wavelength light signal, detector 108 is configured to detect visible wavelength light signals, e.g., if light source 106 is an infrared laser, detector 108 is configured to detect infrared wavelength light signal.

Light source 106 and detector 108 can be arranged with respect to one another such that light signal 110 emitted from light source 106 can be detected by detector 108, for example, such that the light source 106 and detector 108 are arranged along an axis A and facing each other.

In some implementations, light source 106 and detector can be affixed to , embedded in, or otherwise a part of an inner surface of a volume, e.g., an inner surface of an insert 112. Insert 112 can be configured to be inserted into one or more standard sized parts bins. Insert 112 can be attached to a parts bin using attachment points, for example, using snaps, tabs, screws, latches, adhesive, or other similar methods/mechanisms. Insert 112 can additionally or alternatively be compression fit into a parts bin. Insert 112 can be supported within the parts bin without attachment points/compression fit. Insert 112 can include one or more adjustable components to adjust one or more dimensions of the insert 112 to fit within a given parts bin. In one example, a width and height of the insert 112 can have adjustable lengths such that insert 112 has a same outer perimeter as an inner perimeter of a parts bin.

Smart parts bin 102 includes a signal source 114. The signal source 114 can be configured to output one or more types of signals, i.e., the signal source is an LED that can output a red light signal and/or a green light signal. In some implementations, signal source 114 includes one or more light sources (e.g., one or more LEDs), an audio source (e.g., a speaker), a visual display (e.g., a light crystal display (LCD), an organic light emitting diode (OLED) display, or another visual display which may optionally include a touch-screen function, or another audio/visual signal source. For example, signal source 114 includes two LEDs of different emission wavelengths, e.g., a red LED and a green LED, that can each be indicative of a state of the inventory level of the smart parts bin 102, e.g., below or above a threshold inventory level 111. The signal source 114 can be configured to output one or more types of signals to reflect a state of the inventory level of the smart parts bin 102, i.e., in response to a detection signal from detector 108, as will be described in further detail below.

Smart parts bin 102 includes a control unit 116 in data communication with light source 106, detector 108, and signal source 114 via a wired network or wireless network, e.g., Bluetooth, Wi-Fi, Zigbee, local area network (LAN), wide area network (WAN), or the like. Control unit 116 can be, for example, a microcontroller and/or system on a chip. Control unit 116 can be for example, a microcontroller and/or system on a chip. Control unit 116 can include a power source to provide operational power to the light source 106, detector 108, control unit 116, and signal source 114. A power source can be, for example, a battery source, a capacitor, or another device that can store power. Control unit 116 can be connected to a 110 volt or 220 volt power source from an external power source (e.g., from a building including the smart parts bin 102) in order to receive 12 volts (e.g., using a 12 volt power supply) for operating the components of the smart parts bin 102.

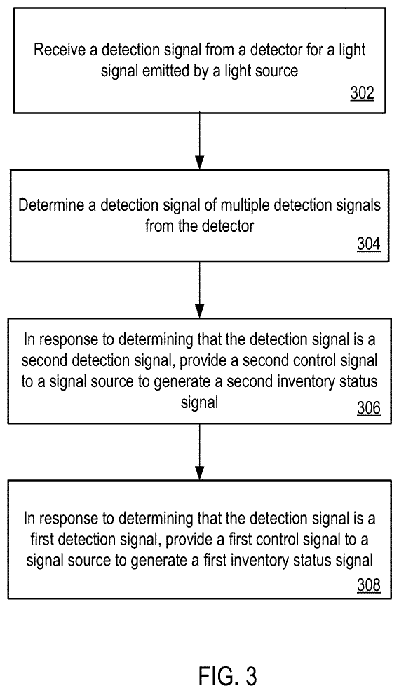

Control unit 116 can be configured to provide control signals and/or receive data from one or more of the light source 106, detector 108, and signal source 114. In some implementations, the control unit 116 is configured to provide a control signal to the light source 106, e.g., to turn light source on/off. Control unit 116 can be configured to receive detection signals from detector 108, e.g., signals from detector 108 of a detection of light signal 110 or no detection of light signal 110. Control unit 116 can be configured to provide control signals to signal source 114, e.g., to change a state of a visual indicator, to turn on/off an LED, to produce an audible alert, to display a message on a display screen, or the like. An example process of the operations of the control unit are described below with reference to FIG. 3.

In some implementations, smart parts bin 102 includes a weight sensor 118 in data communication with control unit 116 and configured to measure a weight of inventor items contained within the smart parts bin 102. Weight sensor 118 can perform a differential weight measurement to determine a difference in a weight of an empty smart parts bin 102 and a current weight to determine whether the contents of the smart parts bin 102 is at least a threshold inventory.

In some implementations, smart parts bin 102 can include multiple light source/detector pairs each to measure a respective threshold inventory level within the bin. In other words, each can indicate a level of fullness (e.g., full, half, nearly empty) of the bin based on a location of the light source/detector pair with respect to the insert 112.

In some implementations, smart parts bin 102 is configured to be an insert 112 to retrofit an existing parts bin. The smart parts bin 102 can be inserted into an existing parts bin that includes modifications, e.g., a slot is drilled through a front portion of the existing parts bin to accommodate the signal source (e.g., a hole to accommodate a position of an LED in the front of the parts bin).

In some implementations, the smart parts bin can be an adaptive kit utilized to retrofit an existing parts bin that includes modifications, e.g., a slot is drilled through a front portion of the existing parts bin to accommodate the signal source (e.g., a hole to accommodate a position of an LED in the front of the parts bin). Alternatively, the smart parts bin 102 can be a replacement container for an existing parts bin (i.e., replaces an entire storage system). In some situations, the light source 106, detector 108, and/or signal source 114 can be attached to clips that slide over the edges of an existing parts bin to arrange them at the appropriate height, or can be attached to an existing parts bin using adhesive. When the light source 106, detector 108, and signal source 114 are attached to clips (or another mechanism to affix the light source 106, detector 108, and signal source 114 to an existing parts bin), the clips can be adjustable so that the distance between the top/bottom of the parts bin and the location of the light source 106, detector 108, and signal source 114 can be adjusted. This allows for adjustments to the level of parts at which the LED will change colors, and also allows the light source 106, detector 108, and signal source 114 to be inserted into parts bins of different depths.

In some implementations, smart parts bin 102 is in data communication with a smart inventory system 120 on a server 121 via a network 122, e.g., a wireless or wired connection.

In some implementations, some or all of the process described with reference to control unit 116 can be performed by smart inventory system 120. In some implementations, some or all of the processes of the smart inventory system 120 can be performed on a server 121, e.g., a cloud based server, a local server, or a combination thereof.

Smart inventory system 120 can be in data communication with one or more user devices 124, e.g., mobile phone, tablet, computer, etc. In some implementations, some or all of the processes of the smart inventory system 120 can be performed on user device(s) 124.

Smart inventory system 120 can be configured to receive, from control unit 116, data including information about an inventory status for one or more smart parts bin(s) 102. In some implementations, smart inventory system 120 can be configured to receive inventory statuses from multiple smart parts bins 102, each smart parts bins 102 including a respective control unit 116. Information about an inventory status can include data descriptive of a detection state of the detector 108, e.g., whether the detector 108 is detecting a light signal 110 from light source 106 or not, for example, information can be a binary state of the detection status (e.g., “1” or “0” representing “signal detected” or “signal not detected”).

In some implementations, smart inventory system 120 can generate an alert responsive to the received information about inventory status for a smart parts bin 102. The alert can be generated in the case that the inventory status reflects a “0” state or “signal not detected.” Alerts can include (but are not limited to), for example, inventory updates to one or more user devices 124. The generated alert can be in the form of a SMS/text, phone recording, email, pop-up alert, etc., to a user device 124. The alert can include information about inventory status, reminder to re-order inventory, information about a part within the smart parts bin 102, or the like.

In some implementations, smart inventory system 120 can be a part of an inventory control system which may include additional features related to inventory control, process flow, purchasing, vendor information, etc.

In some implementations, smart parts bins 102 containing different parts can include different types of visual alerts, e.g., high priority parts can include a first type of alert (audio and visual) and low priority parts can include a second type of alert (only visual).

As depicted in FIG. 1B, the level of the inventory product 130 within the smart parts bin 102 is at least a threshold inventory level 111 to block the light signal emitted from the light source 106 such that the detector 108 does not detect the blocked light signal 132. The detector 108 can provide, to the control unit 116 a signal including data indicative of a change in detected signal (e.g., “no signal” to “signal”) which is reflective of a change in inventory level of product 130 within the smart parts bin that is below a threshold inventory level 111.

The control unit 116 can provide, in response, a control signal to the signal source 114 (e.g., an LED) to change a visual appearance of the signal source 114 in response. In one example, the control unit 116 can provide, in response, a control signal to the signal source 114 to change the color of the LED from green to red. (or turn off green LED and turn on a red LED). In another example, the control unit 116 can provide a control signal to signal source 114 to generate an audible alert (e.g., a chirping sound). In another example, the control unit 116 can provide a control signal to signal source 114 to turn on an LED (for a single LED system). In another example, the control unit 116 can provide a control signal to signal source 114 to display a text-based message on a display screen (e.g., “refill parts”).

In some implementations, the control unit 116 can provide, to the smart inventory system 120 data including information regarding the smart parts bin and a contents of the smart parts bin.

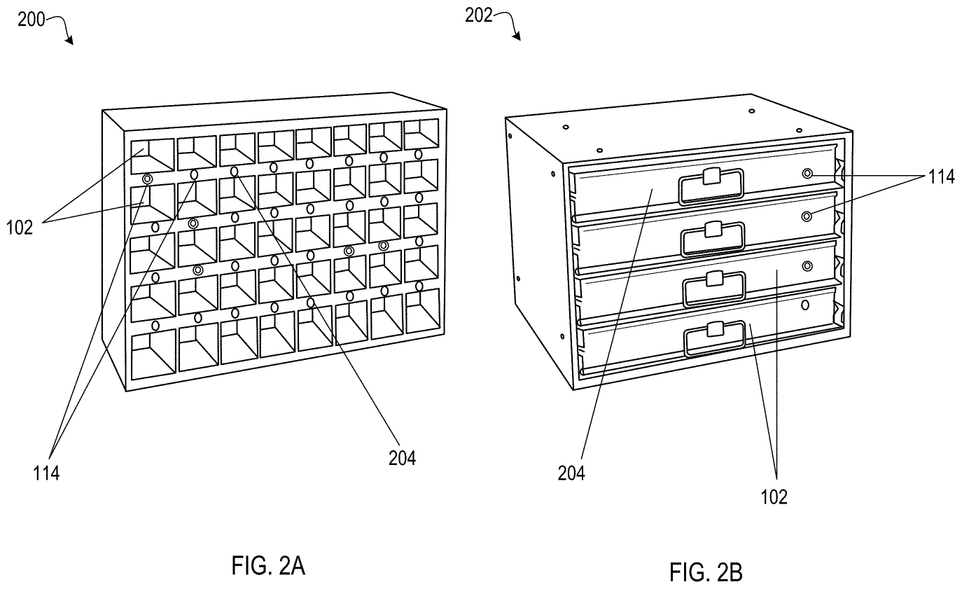

FIGS. 2A-2B are examples of smart parts bins systems. FIGS. 2A and 2B each depict generic types of storage systems 200, 202 that can implement the smart parts bins 102 as described herein. Example signal sources 114, e.g., LEDs, are visible from a front panel 204 of each of the storage systems 200, 202, where a signal source is located at a front panel 204 of each smart parts bin 102 of the storage system 200, 202.

In some implementations, a manufacturing/fabrication facility can include multiple storage systems 200, 202, where the multiple storage systems 200, 202 can include smart parts bins 102.

FIG. 3 is a flow diagram of an example process 300 of the smart parts bin. Though described as actions performed by the control unit 116, a portion or all of the actions described with reference to the control unit 116 can be performed by the smart inventory system 120 operating on server 121 or a user device 124.

The control unit receives a detection signal from the detector for the light signal emitted by the light source (302). As described with reference to FIGS. 1A-1B, control unit 116 receives a detection signal from detector 108, where a detection signal can be a “no signal” or “signal” detection, e.g., a binary state of whether or not the detector 108 can detect the light signal emitted by light source 106.

The control unit determines a detection signal of a plurality of detection signals from the detector, where the detection signal reflects a number of the one or more parts retained within the volume (304). The control unit 116 determines if the detection signal is a first detection signal, e.g., “no signal,” or a second detection signal, e.g., “signal.” Each of the detection signals are indicative of a state of inventory of parts retained within the smart parts bin, e.g., a number of parts that are within the smart parts bin. As described above with reference to FIGS. 1A and 1B, a light signal 110 emitted from light source 106 can be detected by the detector 108 to generate a first detection signal when a level of product 130 (e.g., a number of parts within the insert 112) is below a threshold inventory level 111, and blocked light signal 132 will result in a second detection signal when the level of product 130 is above the threshold inventory level 111.

In response to the determination that the detection signal from the detector is a first detection signal, the control unit provides a first control signal to the signal source to generate a first inventory status signal (306). In some implementations, the first detection signal is a “no signal” detection signal from the detector. In other words, that the level of product 130 retained within the insert 112 is above the threshold inventory level 111, e.g., as depicted in FIG. 1B. The control unit 116 can provide to the signal source 114, e.g., an LED, a control signal to set the LED emission output to “green” (i.e., indicating a threshold amount of inventory within the smart parts bin 102).

In response to the determination that the detection signal from the detector is a second detection signal, the control unit provides a second control signal to the signal source to generate a second inventory status signal (308). In some implementations, the second detection signal is a “signal” detection signal from the detector. In other words, that the level of product 130 retaining within the insert 112 is below the threshold inventory level 111, e.g., as depicted in FIG. 1A. The control unit 116 can provide to the signal source 114, e.g., the LED, a control signal to set the LED emission output to “red” (i.e., indicating that the amount of inventory within the smarts part bin 102 is below a threshold amount).

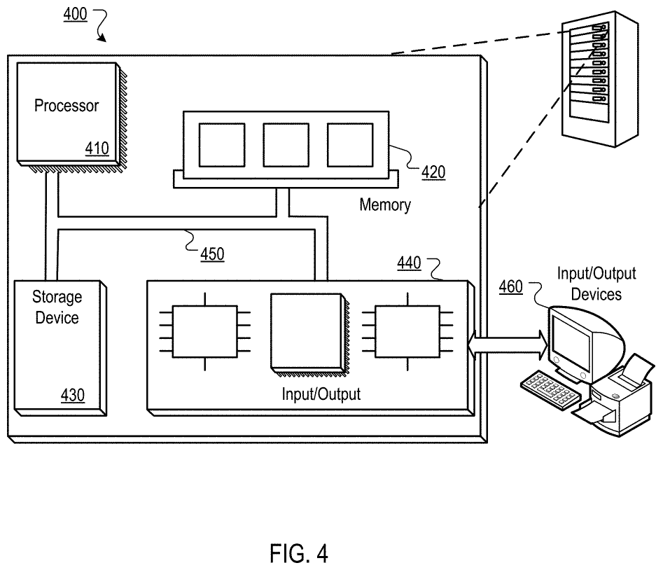

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 460, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A smart parts bin apparatus comprising:
a light source configured to emit a light signal;
a detector configured to detect the light signal emitted by the light source;
an inner surface defining a volume configured to retain one or more parts, wherein the light source and the detector are each affixed to the inner surface and arranged on opposing sides of the inner surface within the volume; and
a signal source configured to provide an inventory status signal, wherein (i) the signal source outputs a first type of signal when the light signal emitted by the light source is not detected by the detector indicating that a level of parts in the smart parts bin apparatus is above a threshold inventory level, and (ii) the signal source outputs a second type of signal when the light signal emitted by the light source is detected by the detector indicating that the level of parts in the smart parts bin apparatus is below the threshold inventory level.

2. The smart parts bin apparatus of claim 1, further comprising a control unit in data communication with the light source, detector, and signal source, and configured to perform operations comprising:
receiving, by the control unit, a detection signal from the detector for the light signal emitted by the light source;
determining, by the control unit, a detection signal of a plurality of detection signals from the detector, wherein the detection signal reflects a number of the one or more parts retained within the volume;
in response to the determination that the detection signal from the detector is a first detection signal, provide a first control signal to the signal source to generate a first inventory status signal; and
in response to the determination that the detection signal from the detector is a second detection signal, provide a second control signal to the signal source to generate a second inventory status signal.

3. The smart parts bin apparatus of claim 1, wherein the first detection signal comprises no detection of the light signal emitted by the light source,
and wherein the second detection signal comprises detection of the light signal emitted by the light source.

4. The smart parts bin apparatus of claim 1, wherein the signal source comprises a light emitting diode (LED).

5. The smart parts bin apparatus of claim 4, wherein the first inventory status signal comprises setting the LED to emit a first light signal, and wherein the second inventory status signal comprises setting the LED to emit a second light signal.

6. The smart parts bin apparatus of claim 1, wherein the light source is an LED and the detector is one of a photodiode, CCD, CMOS camera, phototransistor, or photoresistor.

7. The smart parts bin apparatus of claim 1, wherein the operations further comprise:
providing, to an smart inventory system, an alert comprising information regarding the detection signal.
